(19) United States
(12) Patent Application Publication
(10) Pub. No.: US 2018/0219683 A1
(43) Pub. Date: Aug. 2, 2018

(54) Possession and Alteration of Documents

(71) Applicant: Factom, Austin, TX (US)

(72) Inventors: Brian Deery, Austin, TX (US); Jason Nadeau, Missouri City, TX (US); Paul Snow, Austin, TX (US); Mahesh Paolini-Subramanya, Austin, TX (US)

(21) Appl. No.: 15/419,042

(22) Filed: Jan. 30, 2017

(51) Int. Cl. H04L 9/32; H04L 29/06; H04L 9/06

(52) U.S. Cl. CPC H04L 9/3239; H04L 9/0637; H04L 63/083

(57) ABSTRACT

Possessory claims may be verified. When any entity claims to possess an electronic document, a verification scheme may require verification numbers associated with the electronic document. If the correct verification numbers are provided, then a claimant may actually possess the electronic document. However, if the correct verification numbers cannot be provided, then the verification scheme may deny that the claimant has the electronic document.

### COPYRIGHT NOTIFICATION

A portion of this patent document and its attachments contain material which may be subject to copyright protection. The copyright owner has no objection to the facsimile reproduction of the patent document or its attachments, as it appears in the Patent and Trademark Office patent files or records, but the copyright owner otherwise reserves all copyrights whatsoever.

### BACKGROUND

Security is important in today's online environment. One reads nearly every day of another hacking. People's data is even being held ransom.

### BRIEF DESCRIPTION OF THE SEVERAL VIEWS OF THE DRAWINGS

The features, aspects, and advantages of the exemplary embodiments are understood when the following Detailed Description is read with reference to the accompanying drawings, wherein:

FIGS. 1-6 are simplified illustrations of verifying a possession of an electronic document, according to exemplary embodiments;

FIGS. 7-8 are detailed illustrations of an operating environment, according to exemplary embodiments;

FIGS. 9-11 illustrate division of the electronic document, according to exemplary embodiments;

FIGS. 12-13 illustrate hashing, according to exemplary embodiments;

FIGS. 14-18 illustrate a verification scheme, according to exemplary embodiments;

FIG. 19 further illustrates the verification scheme, according to exemplary embodiments;

FIG. 20 illustrates regeneration of a hash tree, according to exemplary embodiments;

FIG. 21 is a flowchart illustrating a method of verification, according to exemplary embodiments; and

FIGS. 22-23 depict still more operating environments for additional aspects of the exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

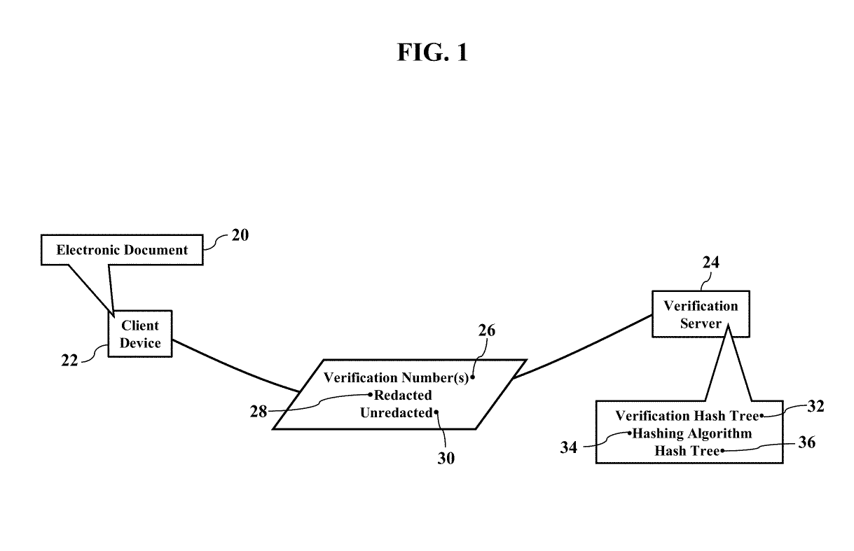

FIGS. 1-6 are simplified illustrations of verifying a possession of an electronic document 20, according to exemplary embodiments. Here exemplary embodiments verify whether a client device 22 possesses a true, unaltered copy of the electronic document 20. As the reader may understand, the authenticity of the electronic document 20 may be very important in banking, security, identification, and other activities conducted via the Internet. If the electronic document 20 has been unwittingly (or even intentionally) changed, then a user's identity, financial accounts, and other online activities may be compromised. So, when the client device 22 claims to possess the electronic document 20, exemplary embodiments may infer whether that possessory claim is true or false.

FIG. 1 thus illustrates a verification server 24. When the client device 22 claims to possess, store, or have access to the electronic document 20, the client device 22 sends verification numbers 26 allegedly associated with the electronic document 20. The verification numbers 26 may be predetermined and/or randomly assigned and associated with the electronic document 20 (as later paragraphs will explain). The verification numbers 26 may even represent redacted portions 28 and/or unredacted portions 30 of the electronic document 20 (as later paragraphs will also explain). The client device 22 submits the verification numbers 26 as evidence and/or proof of the alleged possession of the electronic document 20. When the verification server 24 receives the verification numbers 26, the verification server 24 may generate values associated with a verification hash tree 32 based on the verification numbers 26. The verification hash tree 32 may be generated using an electronic representation of a hashing algorithm 34. The verification server 24 may then compare the verification hash tree 32 to a hash tree 36 known to be associated with the electronic document 20. If the verification hash tree 32 satisfactorily compares to the hash tree 36, then the verification server 24 may infer or determine that the client device 22 actually possesses the true, unaltered copy of the electronic document 20. The verification hash tree 32, in other words, may substantially or even exactly match the hash tree 36 known to be associated with the electronic document 20. If, however, the verification hash tree 32 fails to satisfy the hash tree 36, then the verification server 24 may infer that the client device 22 possess an altered or forged version of the electronic document 20. Exemplary embodiments may thus refuse or decline any transaction associated with the client device 22 as untrustworthy or even malicious.

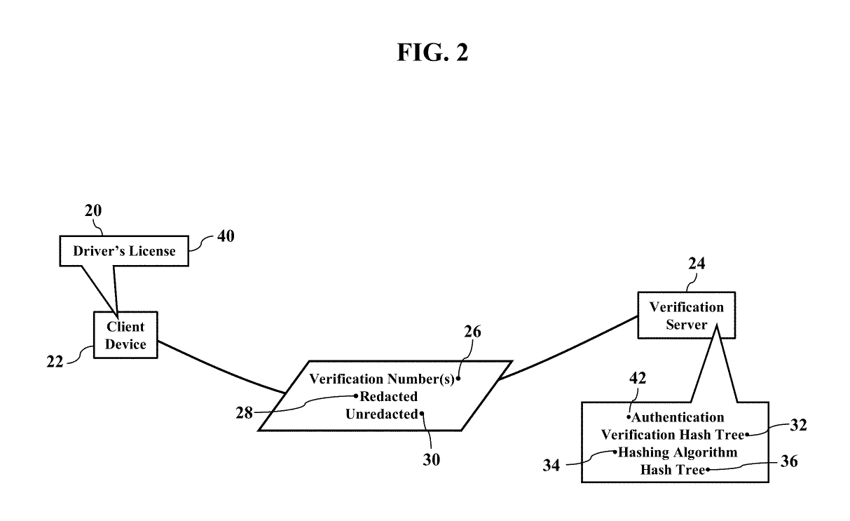

FIG. 2 illustrates a simple example. Suppose a user of the client device 22 claims to store/possess a true and unaltered electronic copy of a driver's license 40. As the reader likely understands, the driver's license 40 may be used for many purposes (such as for identification). In this example, assume the user is required to send/submit a true, digital copy of the driver's license 40 to authenticate to the verification server 24. When the client device 22 requests an authentication 42, the client device 22 sends the verification numbers 26 allegedly associated with the driver's license 40. The verification server 24 generates the verification hash tree 32 based on the verification numbers 26 sent from the client device 22. The verification server 24 may then compare the verification hash tree 32 to the hash tree 36 known to be associated with the driver's license 40. If a substantial match is determined, then the verification server 24 may authenticate the client device 22 based on storage of the true, unaltered copy of the driver's license 40. However, if the verification hash tree 32 fails to match or satisfy the hash tree 36 known to be associated with the driver's license 40, then the verification server 24 may decline or fail the authentication 42. The client device 22, in other words, possesses the altered/forged version of the driver's license 40.

Exemplary embodiments thus describe an elegant solution. When the possession of the electronic document 20 is challenged, exemplary embodiments quickly and simply verify whether the client device 22 truly stores the electronic document 20. Values associated with the hash tree 36 may be predetermined, stored, and then retrieved for comparison to the verification hash tree 32. The client device 22 may therefore be required to provide the same data (e.g., tuples comprising the verification numbers 26) that generate the same hash tree 36. The verification numbers 26 are thus based on the electronic document 20, and the verification numbers may need to be exactly submitted to generate the matching verification hash tree 32.

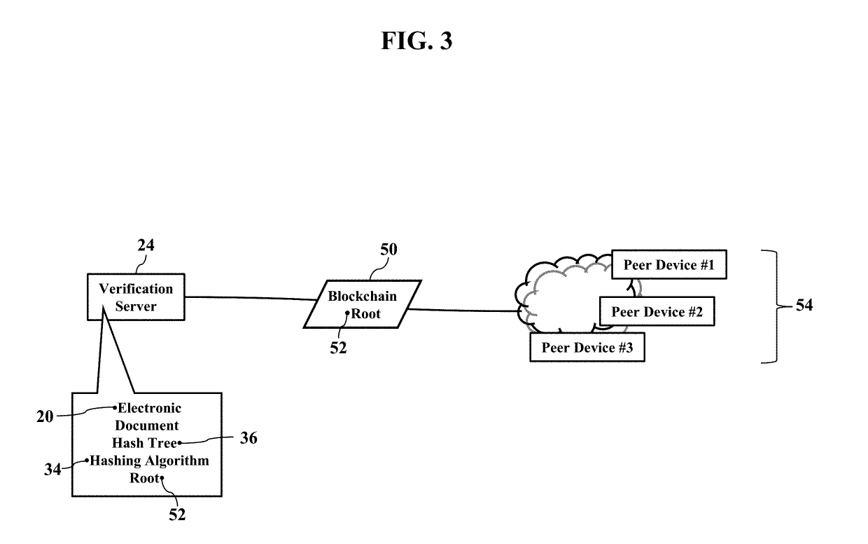

FIG. 3 illustrates a blockchain 50, according to exemplary embodiments. Here exemplary embodiments may utilize the blockchain 50 as a distribution or publication mechanism. As the reader may understand, the blockchain 50 is generally a digital ledger in which transactions are chronologically and/or publically recorded. The blockchain 50 is most commonly used in decentralized cryptocurrencies (such as Bitcoin). The blockchain 50, however, may be adapted to any chain or custody (such as in medical records and in chains of title in real estate transactions). Indeed, there are many different mechanisms and configurations of the blockchain 50, and exemplary embodiments may be adapted to any version.

The verification server 24 may utilize the blockchain 50. The verification server 24 may call or execute the hashing algorithm 34 that generates the hash tree 36 associated with the electronic document 20. The hashing algorithm 34 may also compute or identify a root 52 associated with the hash tree 36. There are many hashing algorithms, and exemplary embodiments may utilize any of the hashing algorithms. For simplicity, though, this disclosure will mostly discuss the SHA family of cryptographic hashing algorithms, which many readers are thought familiar. Moreover, the hash tree 36 may be described as the Merkle tree, which many readers are also thought familiar. Regardless, once the root 52 (such as the Merkle root) is determined, exemplary embodiments may integrate the root 52 into the blockchain 50. That is, the root 52 may be added to, or incorporated in, any record, transaction, or block and distributed via the blockchain 50. Indeed, if desired, exemplary embodiments may additionally or alternatively integrate any portion or even all of the hash tree 36 values (e.g., hash list, hash chain, branches, nodal leaves) in the blockchain 50.

The blockchain 50 is distributed. Once the verification server 24 integrates the root 52 and/or the hash tree 36 in the blockchain 50, exemplary embodiments may timestamp and distribute the blockchain 50. While the blockchain 50 may be sent or routed to any destination (such as an Internet Protocol address associated with another server), FIG. 3 illustrates peer distribution. That is, the verification server 24 may broadcast the blockchain 50 to the IP addresses associated with a network 54 of peer devices or nodes for verification. The blockchain 50, in other words, is distributed to trusted peers for further verification. Because peer-to-peer blockchain technology is generally known, exemplary embodiments need not provide a detailed explanation.

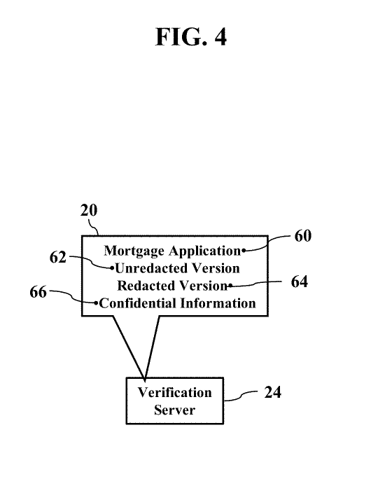

FIG. 4 illustrates a redaction of the electronic document 20. Here the verification server 24 may store the electronic document 20 and discern an unredacted version 62 from a redacted version 64. Again, while the electronic document 20 may have any content, most readers are thought familiar with a mortgage application 60. That is, the electronic document 20 may be a web-based, portable document format (PDF) associated with an applicant's personal and financial records for obtaining a mortgage. As the reader understands, the mortgage application 60 includes confidential information 66, such as an applicant's social security number, income, and banking records. As the mortgage application 60 is processed toward approval, some people or entities are denied or forbidden access to the confidential information 66. The verification server 24 (or any other entity) may thus generate the true, unredacted version 62 having no information redacted therefrom. However, the verification server 24 may also generate the redacted version 64 having the confidential information 66 blacked out, removed, or altered. The redacted version 64 may then be distributed for processing. Indeed, some or all of the redacted version 64 may even be publically disclosed to the Internet or publically recorded.

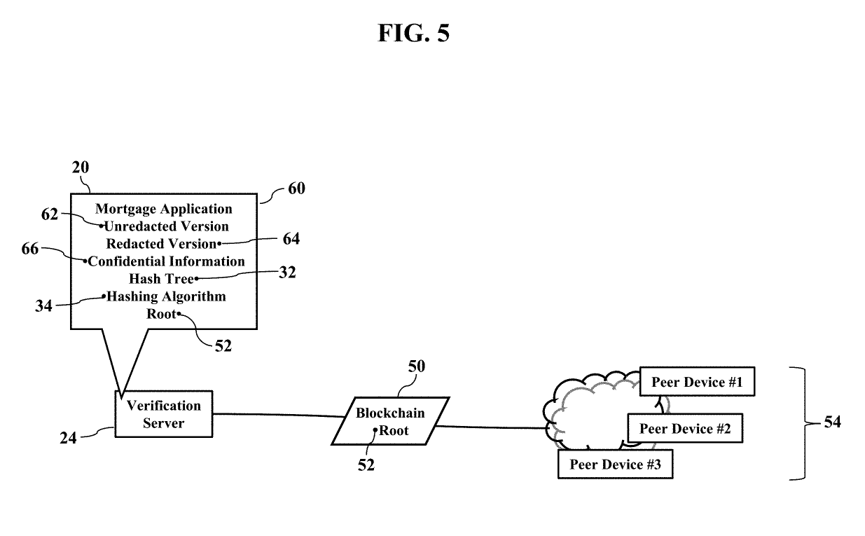

FIG. 5 illustrates hashing and distribution. Here exemplary embodiments may use secure hashing to distinguish the unredacted version 62 from the redacted version 64 of the electronic document 20. Exemplary embodiments may use any data associated with the unredacted version 62 and the hashing algorithm 34 to generate the hash tree 32 and the root 52 (again, as this disclosure will later explain). The verification server 24 may also integrate the root 52 into the blockchain 50 for distribution (perhaps to the network 54 of peer devices, as earlier explained).

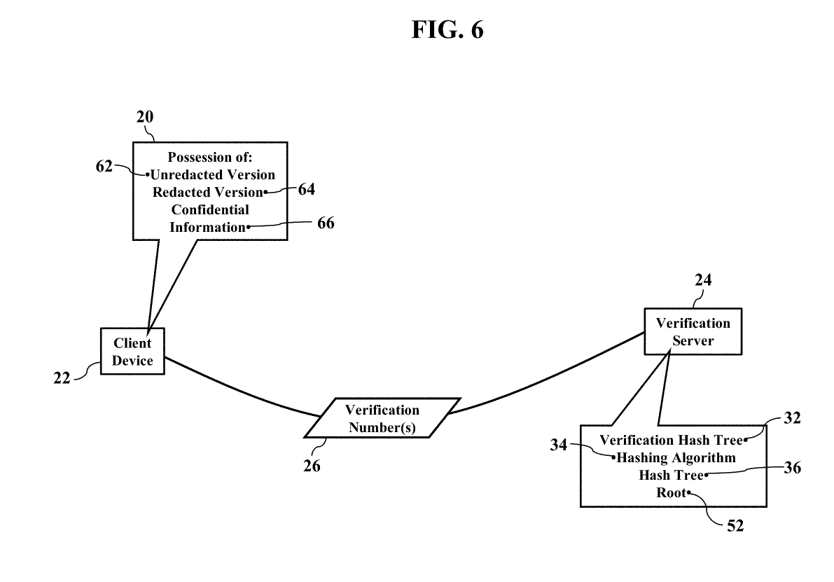

FIG. 6 illustrates verification. Should any entity claim to possess the unredacted version 62, exemplary embodiments may quickly and simply verify the claim of possession. Again, if the unredacted version 62 is truly possessed, then the claimant (perhaps using the client device 22) has access to the social security number, income, banking, and other personal and/or confidential information 66. The unredacted version 62 may thus be nefariously used by a rogue entity. The verification server 24 may thus challenge the claim of possession by requiring the verification numbers 26. When the verification server 24 receives the verification numbers 26, the verification server 24 may generate the verification hash tree 32 (using the hashing algorithm 34) based on the verification numbers 26 sent by the client device 22. The verification server 24 may then compare the verification hash tree 32 to the hash tree 36 generated using the unredacted version 62. If the verification hash tree 32 favorably compares to the hash tree 36, then the verification server 24 may confirm that the client device 22 actually possesses the unredacted version 62 of the electronic document 20. However, if the verification hash tree 32 fails to satisfy the hash tree 36, then the verification server 24 may infer that the client device 22 actually possess the redacted version 64 of the electronic document 20.

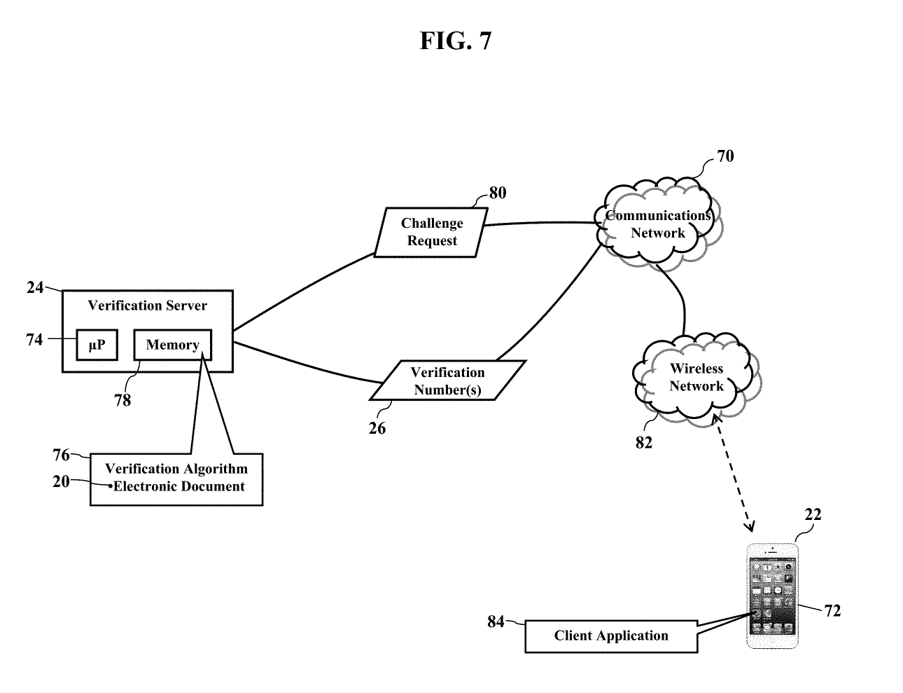

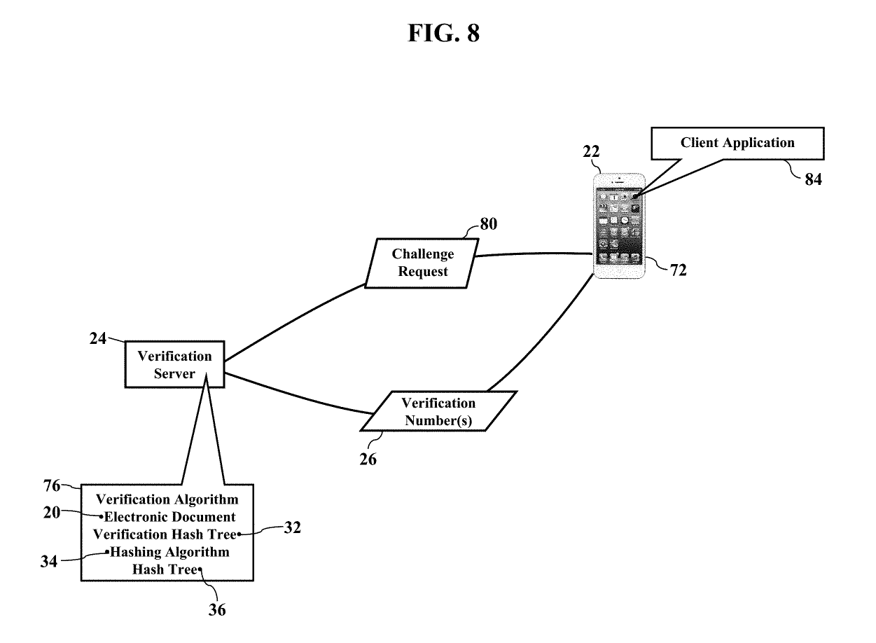

FIGS. 7-8 are detailed illustrations of an operating environment, according to exemplary embodiments. FIG. 7 illustrates the verification server 24 communicating with the client device 22 via a communications network 70. While the client device 22 may be any processor-controlled device, FIG. 7 illustrates a mobile smartphone 72, which most readers are thought familiar. Should a user of the smartphone 72 claim to possess (or have access to) the electronic document 20, the verification server 24 manages verification of that possessory claim. The verification server 24 may have a processor 74 (e.g., “μP”), application specific integrated circuit (ASIC), or other component that executes a verification algorithm 76 stored in a local memory device 78. The verification algorithm 76 includes instructions, code, and/or programs that cause the verification server 24 to perform operations, such as challenging possessory claims. The verification server 24, for example, may send a challenge request 80 that routes via the communications network 70 (and perhaps a wireless network 82) to the network address (IP address) associated with the smartphone 72.

FIG. 7 also illustrates the verification numbers 26. When the smartphone 72 receives the challenge request 80, the challenge request 80 causes or instructs the smartphone 72 to transmit or send the verification numbers 26 associated with the electronic document 20. The smartphone 72 stores and executes a client application 84 (e.g., a mobile “app”) (using a processor and memory device, not shown for simplicity). The client application 84 includes instructions, code, and/or programs that cause the smartphone 72 to perform operations, such as retrieving and packaging the verification numbers 26 as a response to the challenge request 80. The response is sent and routed via the communications network 70 to the network address (IP address) associated with the verification server 24.

FIG. 8 illustrates verification. The smartphone 72 submits the verification numbers 26 as evidence and/or proof of the alleged possession of the electronic document 20. When the verification server 24 receives the verification numbers 26, the verification algorithm 76 may generate the verification hash tree 32 based on the verification numbers 26 (using the hashing algorithm 34). The verification server 24 may then compare the verification hash tree 32 to the hash tree 36 known to be associated with the electronic document 20. The hash tree 36, in other words, may be based on the data associated with the electronic document 20. If the verification hash tree 32 partially or exactly matches the hash tree 36, then the verification algorithm 76 may infer or determine that the smartphone 72 actually has access to the true, unaltered copy of the electronic document 20, based on possession of the correct verification numbers 26. If the verification hash tree 32 fails to partially or exactly match the hash tree 36, then the verification algorithm 76 may deny the possessory claim. Exemplary embodiments may thus refuse or decline any transaction associated with the smartphone 72.

Exemplary embodiments may be applied regardless of networking environment. Exemplary embodiments may be easily adapted to stationary or mobile devices having cellular, wireless fidelity (WI-FI®), near field, and/or BLUETOOTH® capability. Exemplary embodiments may be applied to mobile devices utilizing any portion of the electromagnetic spectrum and any signaling standard (such as the IEEE 802 family of standards, GSM/CDMA/TDMA or any cellular standard, and/or the ISM band). Exemplary embodiments, however, may be applied to any processor-controlled device operating in the radio-frequency domain and/or the Internet Protocol (IP) domain. Exemplary embodiments may be applied to any processor-controlled device utilizing a distributed computing network, such as the Internet (sometimes alternatively known as the “World Wide Web”), an intranet, a local-area network (LAN), and/or a wide-area network (WAN). Exemplary embodiments may be applied to any processor-controlled device utilizing power line technologies, in which signals are communicated via electrical wiring. Indeed, exemplary embodiments may be applied regardless of physical componentry, physical configuration, or communications standard(s).

Exemplary embodiments may utilize any processing component, configuration, or system. Any processor could be multiple processors, which could include distributed processors or parallel processors in a single machine or multiple machines. The processor can be used in supporting a virtual processing environment. The processor could include a state machine, application specific integrated circuit (ASIC), programmable gate array (PGA) including a Field PGA, or state machine. When any of the processors execute instructions to perform “operations”, this could include the processor performing the operations directly and/or facilitating, directing, or cooperating with another device or component to perform the operations.

Exemplary embodiments may packetize. Exemplary embodiments evaluate possessory claims of electronic documents. The client device 22 and the verification server 24 may have network interfaces to the communications network 70 and/or the wireless network 82, thus allowing collection and retrieval of information. The information may be received as packets of data according to a packet protocol (such as the Internet Protocol). The packets of data contain bits or bytes of data describing the contents, or payload, of a message. A header of each packet of data may contain routing information identifying an origination address and/or a destination address associated with any of the client device 22 and the verification server 24.

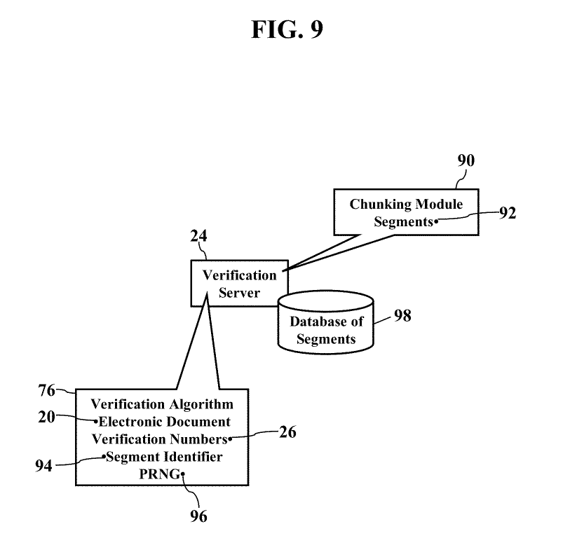

FIGS. 9-11 illustrate division of the electronic document 20, according to exemplary embodiments. Here the verification numbers 26 may be generated and/or assigned based on the electronic document 20. Once the electronic document 20 is generated or saved, exemplary embodiments may divide the electronic document 20 into different parts. The verification algorithm 76, for example, may call or invoke a chunking module 90 that separates the electronic document 20 into multiple segments 92. Each segment 92 may be one or more letters, words, sentences, paragraphs, sections, or even regions within the electronic document 20. The segments 92 may have unequal or equal size (perhaps as measured by the number of textual letters, words, or even physical dimensions on a page within a file). Each segment 92 may also be represented as a defined, variable, or random bit length of 1's and 0's. Once any segment 92 is determined, the verification algorithm 76 may assign an alphanumeric segment identifier 94 that uniquely identifies the segment 92. The verification algorithm 76 may also assign a corresponding verification number 26. The verification algorithm 76, for example, may call or invoke a pseudo-random number generator 96 (or “PRNG”) to generate the corresponding verification number 26. The verification algorithm 76 may then store the segment identifier 94 and its corresponding verification number 26 in a database 98 of segments.

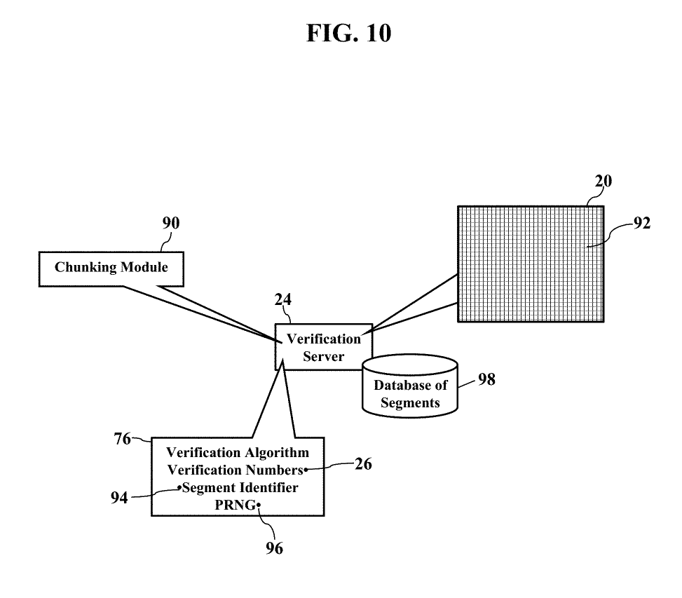

FIG. 10 further illustrates chunking. Here the verification algorithm 76 may use the chunking module 90 to separate the electronic document 20 into equally-sized segments 92. FIG. 10, for simplicity, graphically illustrates the electronic document 20 having hundreds or thousands of different chunks of data. For example, an electronic file (representing the electronic document 20) may be divided into the multiple segments 92, with each segment 92 having 64-bits. Exemplary embodiments may then use these equally-sized segments 92 to recreate the electronic document 20, as later paragraphs will explain.

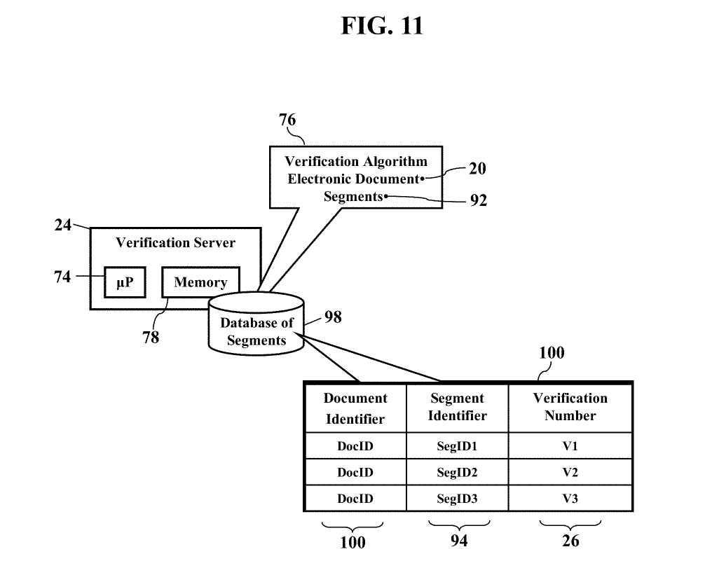

FIG. 11 further illustrates the database 98 of segments, according to exemplary embodiments. As the segments 92 are created, the verification algorithm 76 may add entries to the database 98 of segments. The database 98 of segments is illustrated as being stored in the memory device 78 of the verification server 24. The database 98 of segments, however, may be stored, maintained, and queried from any network location. Moreover, while the database 98 of segments may have any structure or form, FIG. 11 illustrates the database 98 of segments as a table 100 that electronically maps, relates, or associates the different segment identifiers 94 to their corresponding verification numbers 26. The database 98 of segments may even have entries that associate a document identifier 100 that uniquely identifies the electronic document 20. The database 98 of segments may thus define electronic database associations between different documents and their respective segment identifiers 94 and verification numbers 26. While FIG. 11 only illustrates a few entries, in practice the database 98 of segments may contain hundreds, thousands, or even millions of entries for a single electronic document 20. Indeed, the database 98 of segments may be a centralized repository and contain entries for millions of different electronic documents. Regardless, the verification server 24 may query the database 98 of segments for any query term (such as the document identifier 100) and retrieve one or more of the corresponding entries.

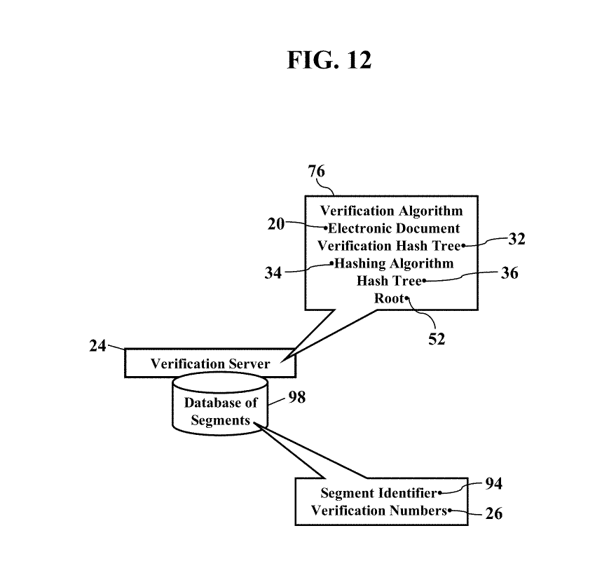

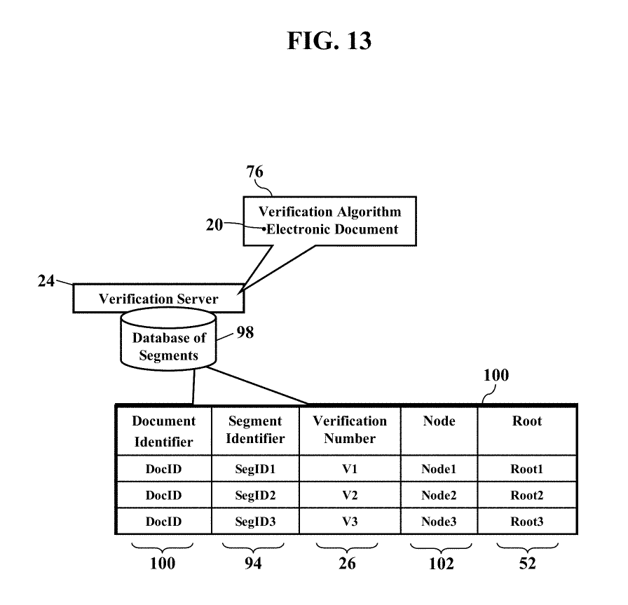

FIGS. 12-13 illustrate hashing, according to exemplary embodiments. Once the segments 92 are determined, the verification algorithm 76 may perform a hashing operation using the hashing algorithm 34. The verification algorithm 76 may use any of the entries in the database 98 of segments as inputs (such as the segment identifiers 94 and/or the verification numbers 26) to generate the hash tree 36 (such as a Merkle tree) and the root 52 (such as the Merkle root). Once the hash tree 36 and the root 52 are generated, the verification algorithm 76 may store values associated with the hash tree 36 (e.g., leaves or nodes). FIG. 13, for example, illustrates the database 98 of segments augmented with hashing data. The database entries may electronically associate the document identifier 100 to its corresponding leaf nodes 102 and any root 52. Exemplary embodiments may thus calculate the root 52 and any other hashing data for long term storage and retrieval. The hashing data, in other words, may be determined once and quickly retrieved without repetitive processing and delay.

Exemplary embodiments may thus quickly generate hash lists. Exemplary embodiments need only query the database 98 of segments to identify, access, or retrieve the electronically associated hashing data. For example, exemplary embodiments may formulate the segment identifiers 94 and the verification numbers 26 as tuples [{segment_id, verification_number}]. Any party claiming possession of the electronic document 20 may have to provide one or more of the tuples as proof.

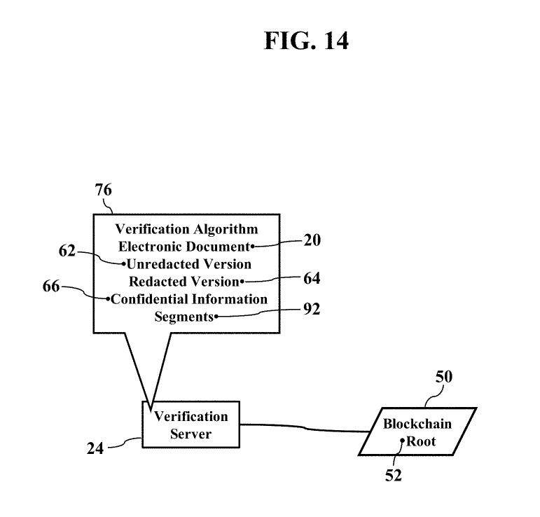

FIGS. 14-18 illustrate a verification scheme, according to exemplary embodiments. Here exemplary embodiments may be used to prove possession of the unredacted version 62 of the electronic document 20. This disclosure previously explained how the electronic document 20 may have the true, unredacted version 62 and the redacted version 64. The redacted version 64 has some data (such as the confidential information 66) blacked out, removed, or altered. The true, unredacted version 62 is divided into the segments 92 and the root 52 is determined (as above explained). The verification server 24 then publically publishes the root 52 (such as integration into the blockchain 50 for distribution, as earlier explained). The root 52, however, may also be published or uploaded to a website URL or other publically-accessible means.

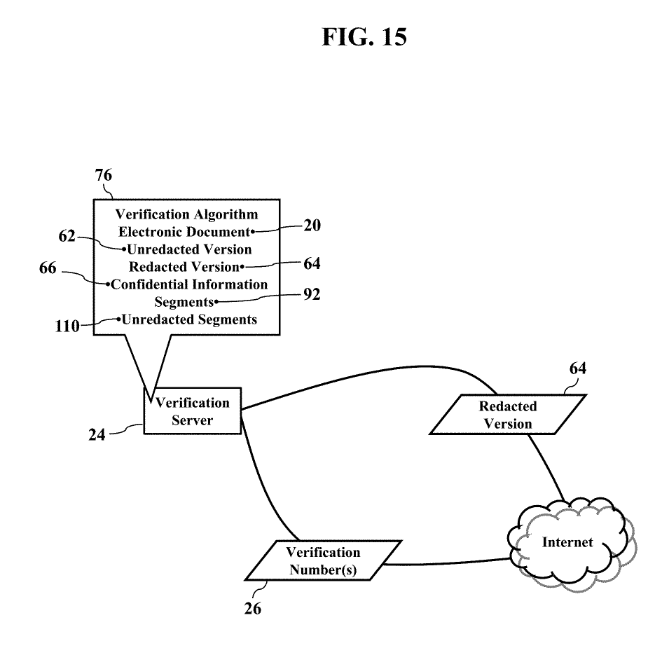

FIG. 15 illustrates publication of the redacted version 64. Once the confidential information 66 has been removed or opaqued or obscured, the redacted version 64 may be intentionally or unintentionally published to the public domain (such as to the Internet). Once the redacted version 64 is publically published or released, exemplary embodiments may publish or release the verification numbers 26. Here, though, exemplary embodiments may only publish the verification numbers 26 that correspond to unredacted segments 110. That is, any verification numbers 26 that correspond to the segments 92 (having the confidential information 66 removed therefrom) are not published and perhaps kept private.

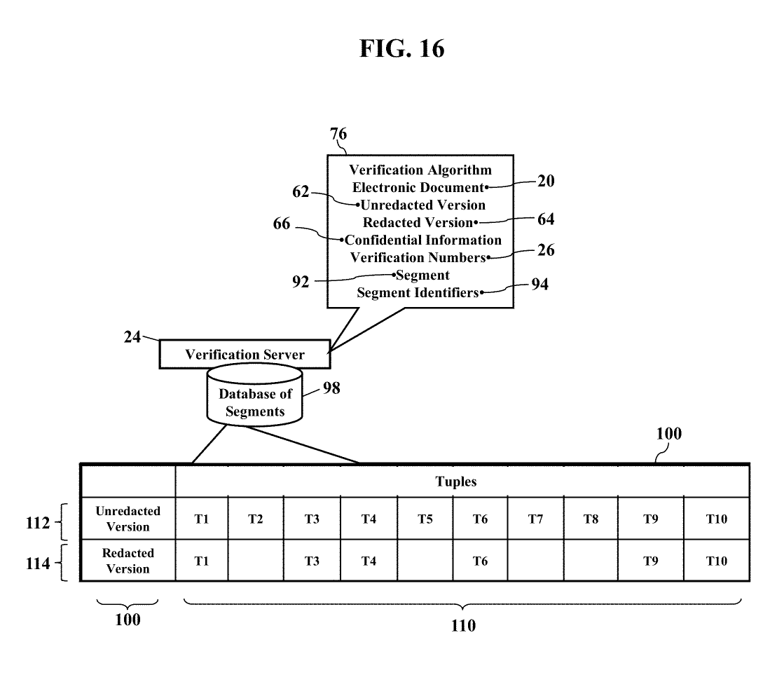

FIG. 16 illustrates the verification numbers 26. The unredacted version 62 of the electronic document 20 may have been divided or segmented into the multiple segments 92 and the verification numbers 26 assigned (as above explained). The redacted version 64 of the electronic document 20 has been altered or modified to remove any information or data (such as the confidential information 66). The database 98 of segments may thus store two (2) or more sets of entries for the same electronic document 20. That is, the database 98 of segments may have entries that electronically associate the tuples 110 [{segment_id, verification_number}] to any entries associated with the unredacted version 62 and with the redacted version 64. That is, the unredacted version 62 may have an entire set 112 of tuples (e.g., the verification numbers 26 and segment identifiers 94) representing every segment 92. The redacted version 64, though, may have a redacted set 114 of tuples that removes values representing the redacted confidential information 66. Exemplary embodiments, in other words, may assign different document identifiers 100 to the respective unredacted version 62 and to the redacted version 64 of the same electronic document 20. Because the database 98 of segments is again illustrated as the table 100, FIG. 16 illustrates different database row associations for the unredacted version 62 and for the redacted version 64. Any verification numbers 26 assigned to segments 92 having the confidential information 66 removed therefrom may be deleted from the redacted set 114 of tuples. Exemplary embodiments may further store or load the database 98 of segments with the corresponding hashing data (such as the hash tree 36 and root 52) based on the entire set 112 of tuples and on the redacted set 114 of tuples. The database 98 of segments, in simple words, has entries that distinguish between the unredacted version 62 and the redacted version 64.

Rogue claims are possible. Now that the redacted version 64 has been publically released (perhaps along with its corresponding redacted set 114 of tuples), any entity may make false claims of possession. That is, an entity may claim possession of the unredacted version 62 (containing the confidential information 66), based merely on the content publically revealed by the redacted version 64. A nefarious hacker, for example, may threaten to reveal social security numbers, photos, or banking information if a ransom is not paid. Exemplary embodiments may thus verify the claim of possession of the unredacted version 62 (containing the confidential information 66).

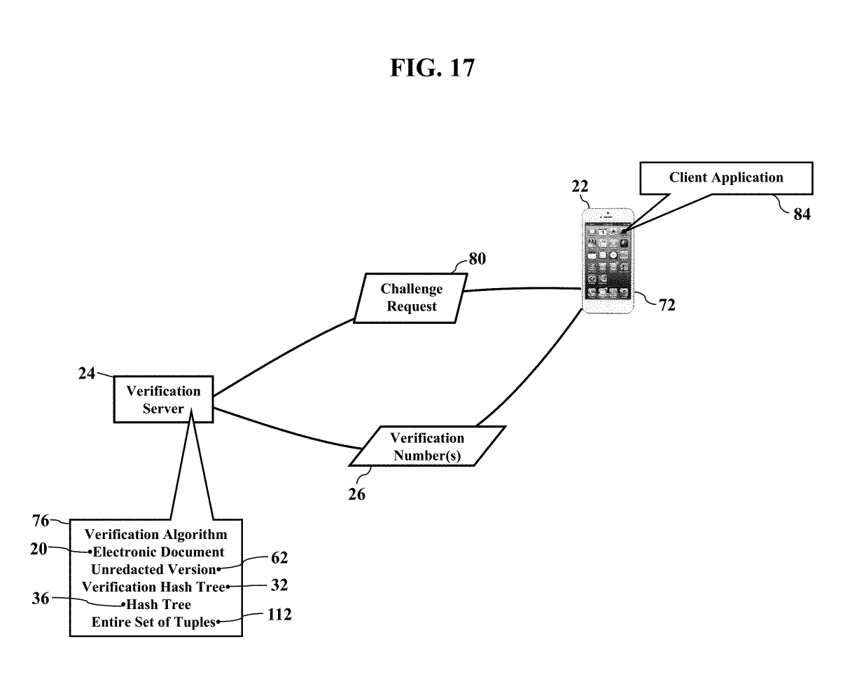

As FIG. 17 illustrates, verification is possible. Should any entity claim to possess the unredacted version 62 of the electronic document 20, exemplary embodiments may quickly and simply verify the claim of possession. The verification algorithm 76 instructs the verification server 24 to send the challenge request 80 to the network address associated with the client device 22 (again illustrated as the smartphone 72). When the smartphone 72 receives the challenge request 80, the challenge request 80 causes or instructs the smartphone 72 to send the verification numbers 26 associated with the electronic document 20. The client application 84 retrieves, packages, and/or sends the verification numbers 26 as evidence and/or proof of the claimed possession. When the verification server 24 receives the verification numbers 26, the verification algorithm 76 may generate the verification hash tree 32 and compare to the hash tree 36 (generated from the entire set 112 of tuples). If the verification hash tree 32 satisfies any comparison threshold or metric, then the verification algorithm 76 may verify the claim of possession. The user of the smartphone 72, in other words, has actual access/possession of the true, unredacted version 62 of the electronic document 20. If the verification hash tree 32 fails to satisfy the hash tree 36 (perhaps according to the comparison threshold or metric), then the verification algorithm 76 may deny the possessory claim.

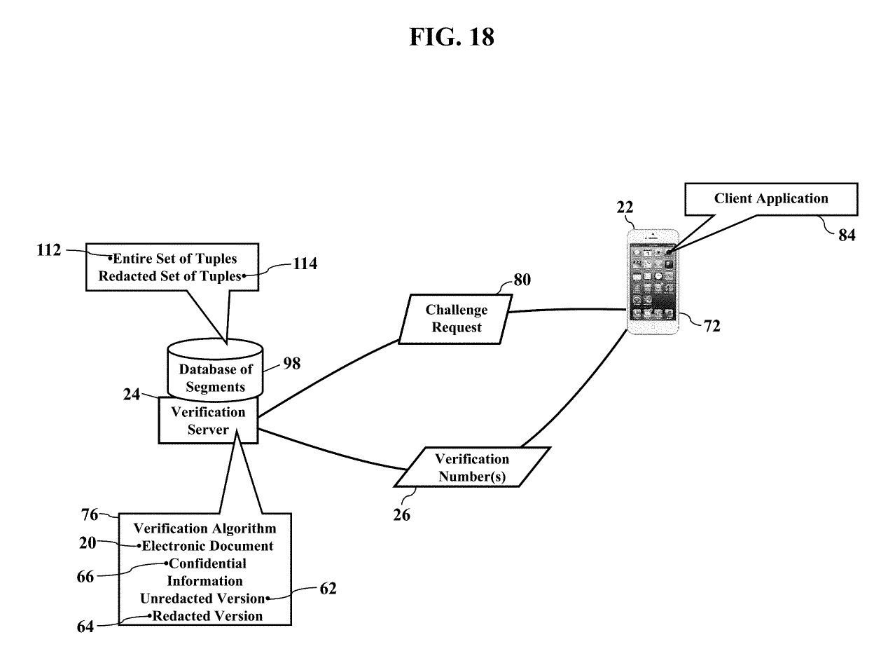

FIG. 18 illustrates another verification. When the verification server 24 receives the verification numbers 26, the verification algorithm 76 may additionally or alternatively query the database 98 of segments. Recall that the database 98 of segments may have entries for both the unredacted version 62 and for the redacted version 64. When the smartphone 72 sends the verification numbers 26, the verification algorithm 76 may test that claim of possession by querying the database 98 of segments for the verification numbers 26. If the verification numbers 26 sent by the smartphone 72 match those contained within or specified by the entire set 112 of tuples, then the verification algorithm 76 may verify the claim of possession. However, if verification numbers 26 sent by the smartphone 72 only match the redacted set 114 of tuples, then the smartphone 72 only has access to or possession of the redacted version 64 of the electronic document 20. The smartphone 72 thus does not have access to the confidential information 66, so any threat is moot.

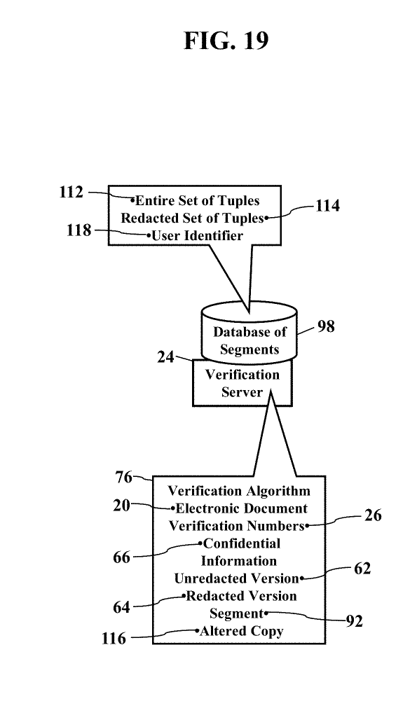

FIG. 19 further illustrates the verification scheme, according to exemplary embodiments. Here exemplary embodiments may be used to prove the redacted version 64 of the electronic document 20 has not been altered. Recall that the redacted version 64 has the confidential information 66 altered or removed to prevent disclosure. As the reader may envision, it is possible (or even probable) that the redacted version 64 itself could be altered or modified after initial creation. Indeed, as the redacted version 64 may be distributed via the Internet and stored, saved, and retrieved by hundreds or thousands of computer machines, the redacted version 64 will likely change (intentionally or unintentionally). Exemplary embodiments may thus detect when the redacted version 64 has been altered.

Exemplary embodiments may utilize the database 98 of segments. Recall that exemplary embodiments may publically publish the redacted version 64, perhaps including the redacted set 114 of tuples. Anyone on the Internet may thus have possession of the redacted version 64 of the electronic document 20. If any party can provide the entire redacted set 114 of tuples, then exemplary embodiments may verify possession of the redacted version 64. That is, if anyone can match the redacted set 114 of tuples that are stored in the database 98 of segments, the verification algorithm 76 may infer possession of the redacted version 64. If a claimant cannot provide or match the redacted set 114 of tuples, then the claimant is bluffing and/or merely possessing an irrelevant document.

Exemplary embodiments may also detect changes to redacted portions. Once the redacted version 64 is initially created and the redacted set 114 of tuples created, the verification algorithm 76 may infer a subsequent alteration to the redacted version 64. If the redacted version 64 is changed after creation, then the verification algorithm 76 may be invoked to generate a second or subsequent redacted set 114 of tuples. That is, if the redacted version 64 is initially created but then subsequently changed, the segments 92 subsequently generated (and the verification numbers 26 assigned thereto) will change from initial values. If any claimant provides verification numbers 26 that differ from initial creation, then exemplary embodiments may infer that the claimant possesses an altered copy 116 of the redacted version 64. Somehow and/or somewhere the redacted version 64 has been altered from its initial creation.

Additional verifications may be inferred. Any claimants possessing the entire set 112 of tuples may be assumed to possess the true, unredacted version 62 of the electronic document 20. If the claimant creates her own redacted version 64, exemplary embodiments may generate the corresponding redacted set 114 of tuples. In other words, anyone possessing their own true, unredacted version 62 of the electronic document 20 may generate multiple and different redacted versions 64. As few users will redact exactly the same portions in exactly the same way, each different redacted version 64 will differ (even slightly). The segments 92 will also different, thus generating multiple, different redacted sets 114 of tuples. Exemplary embodiments may thus track the different redacted versions 64 created by different users. The database 98 of segments, for example, may monitor and store the redacted set 114 of tuples associated with a user identifier 118 (associated with each different user). Any claimant possessing a particular redacted set 114 of tuples may thus be mapped back to the particular user that generated the corresponding redacted version 64. Moreover, because the database 98 of segments may be a centralized repository, the database 98 of segments may be updated with new entries anytime any machine creates the redacted version 64. Exemplary embodiments may thus track which users/machines generate a particular redacted version 64 along with the corresponding redacted set 114 and hashing data.

Still another verification may be inferred. Exemplary embodiments may detect when a particular user changes the redacted version 64. Because exemplary embodiments may track different redacted versions 64, exemplary embodiments may infer when a particular user changes any one of the redacted versions 64. For example, if a user creates two (2) different redacted versions 64 of the same electronic document 20, their corresponding redacted sets 114 of tuples will likely differ. Exemplary embodiments may thus alert or even alarm when multiple redacted versions 64 are created or observed. Moreover, if a user attempts to modify or alter any single redacted version 64, the corresponding redacted set 114 of tuples will likely differ from initial creation. Again, then exemplary embodiments may alert or alarm when a user alters the redacted version 64.

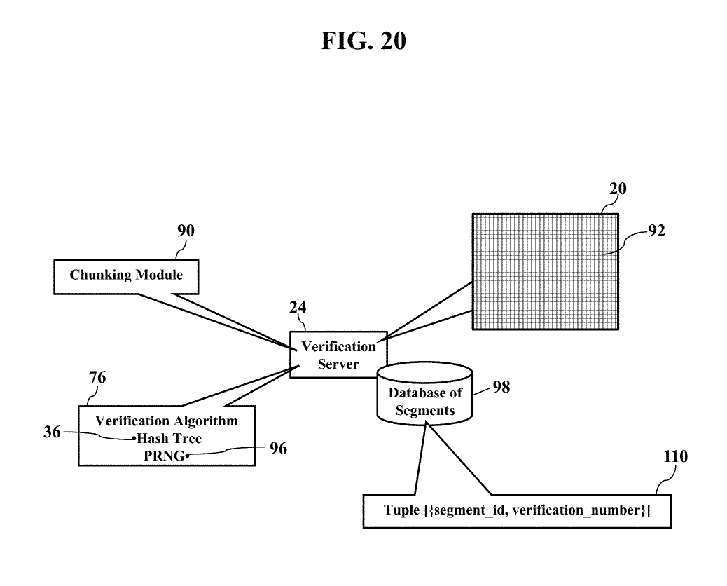

FIG. 20 illustrates regeneration of the hash tree 36, according to exemplary embodiments. Recall that exemplary embodiments may divide the electronic document 20 into the different segments 92. The chunking module 90 may even separate the electronic document 20 into equally-sized segments 92 of sixty four (64) bits each. If the pseudo-random number generator 96 (or “PRNG”) is deterministic, then the resulting tuples 110 [{segment_id, verification_number}] ensures that the hash tree 36 (Merkle) may be created ex nihilo from the original electronic document 20.

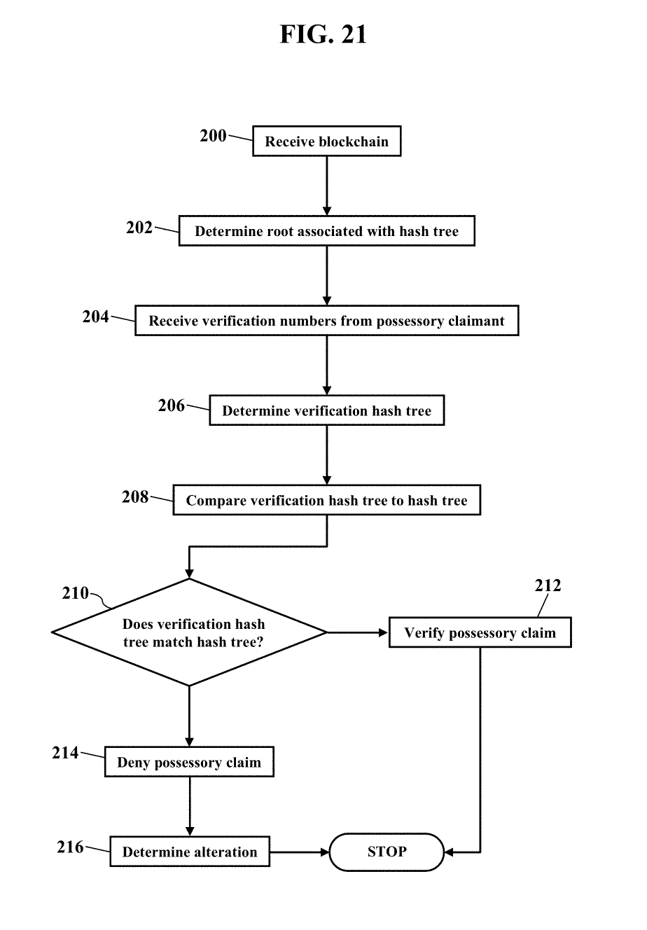

FIG. 21 is a flowchart illustrating a method of verification, according to exemplary embodiments. The blockchain 50 is received (Block 200). The root 52 associated with the hash tree 36 is determined from the blockchain 50 (Block 202). The verification numbers 26 are received (Block 204) from a claimant alleging a possession of the unredacted version 62 of the electronic document 20. The verification hash tree 32 is determined based on the verification numbers 26 (Block 206). The verification hash tree 32 is compared to the hash tree 36 associated with the blockchain 50 to verify the possession of the unredacted version 62 (Block 208). If the verification hash tree 32 matches the hash tree 36 (Block 210), then the claim of possession is verified (Block 212). However, if the verification hash tree 32 fails to match the hash tree 36 (Block 210), the claim of possession may be denied (Block 214) and an alteration of the unredacted document may be determined (Block 216).

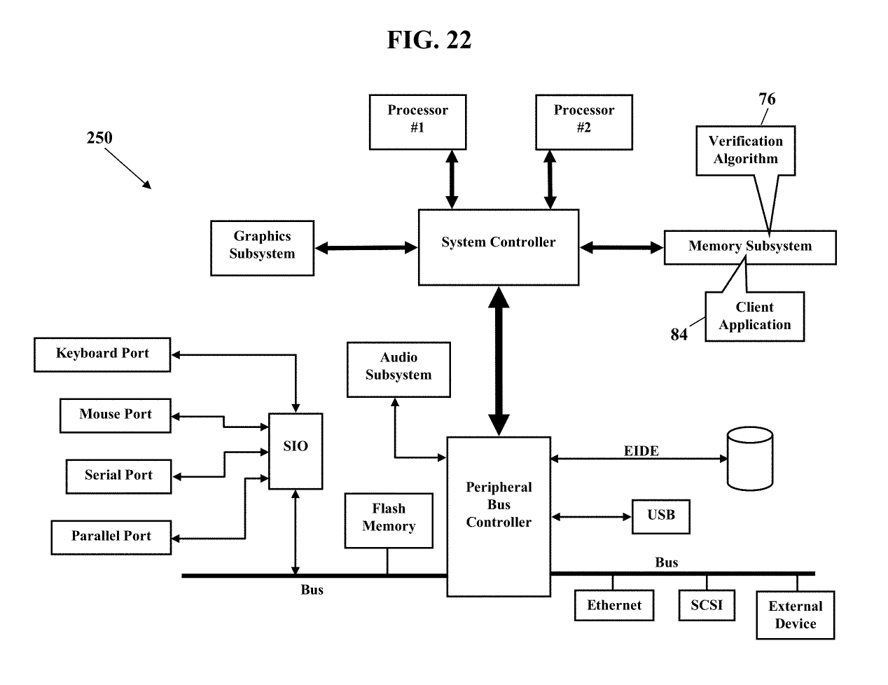

FIG. 22 is a schematic illustrating still more exemplary embodiments. FIG. 22 is a more detailed diagram illustrating a processor-controlled device 250. As earlier paragraphs explained, the verification algorithm 76 and the client application 84 may partially or entirely operate in any mobile or stationary processor-controlled device. FIG. 22, then, illustrates the verification algorithm 76 and the client application 84 stored in a memory subsystem of the processor-controlled device 250. One or more processors communicate with the memory subsystem and execute either, some, or all applications. Because the processor-controlled device 250 is well known to those of ordinary skill in the art, no further explanation is needed.

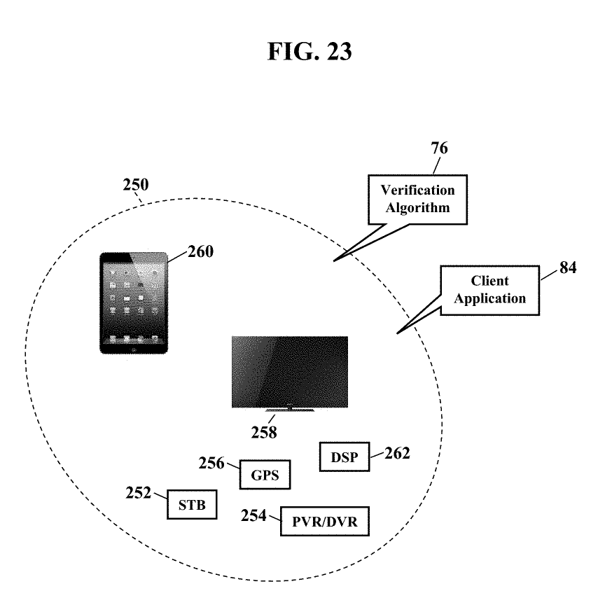

FIG. 23 depicts other possible operating environments for additional aspects of the exemplary embodiments. FIG. 23 illustrates the verification algorithm 76 and the client application 84 operating within various other processor-controlled devices 250. FIG. 23, for example, illustrates that the verification algorithm 76 and the client application 84 may entirely or partially operate within a set-top box (“STB”) (252), a personal/digital video recorder (PVR/DVR) 254, a Global Positioning System (GPS) device 256, an interactive television 258, a tablet computer 260, or any computer system, communications device, or processor-controlled device utilizing any of the processors above described and/or a digital signal processor (DP/DSP) 262. Moreover, the processor-controlled device 250 may also include wearable devices (such as watches), radios, vehicle electronics, clocks, printers, gateways, mobile/implantable medical devices, and other apparatuses and systems. Because the architecture and operating principles of the various devices 250 are well known, the hardware and software componentry of the various devices 250 are not further shown and described.

Exemplary embodiments may be applied to any signaling standard. Most readers are thought familiar with the Global System for Mobile (GSM) communications signaling standard. Those of ordinary skill in the art, however, also recognize that exemplary embodiments are equally applicable to any communications device utilizing the Time Division Multiple Access signaling standard, the Code Division Multiple Access signaling standard, the “dual-mode” GSM-ANSI Interoperability Team (GAIT) signaling standard, or any variant of the GSM/CDMA/TDMA signaling standard. Exemplary embodiments may also be applied to other standards, such as the I.E.E.E. 802 family of standards, the Industrial, Scientific, and Medical band of the electromagnetic spectrum, BLUETOOTH®, and any other.

Exemplary embodiments may be physically embodied on or in a computer-readable storage medium. This computer-readable medium, for example, may include CD-ROM, DVD, tape, cassette, floppy disk, optical disk, memory card, memory drive, and large-capacity disks. This computer-readable medium, or media, could be distributed to end-subscribers, licensees, and assignees. A computer program product comprises processor-executable instructions for verifying possessory claims, as the above paragraphs explained.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

1. A method of verifying a possession of an electronic document, the method comprising:
receiving, by a hardware processor, verification numbers sent via the Internet from a client device, the client device sending the verification numbers to claim the possession of the electronic document;
generating, by the hardware processor, a verification hash tree based on the verification numbers sent by the client device and an electronic representation of a hashing algorithm;
retrieving, by the hardware processor, a hash tree known to be associated with the electronic document; and
comparing, by the hardware processor, the verification hash tree to the hash tree to verify the possession of the electronic document.

2. The method of claim 1, further comprising determining the verification hash tree satisfies the hash tree.

3. The method of claim 2, further comprising verifying the possession of the electronic document claimed by the client device in response to a satisfaction of the verification hash tree compared to the hash tree.

4. The method of claim 1, further comprising determining the verification hash tree fails to satisfy the hash tree.

5. The method of claim 4, further comprising denying the possession of the electronic document in response to the verification hash tree failing to satisfy the hash tree.

6. The method of claim 1, further comprising determining an alteration of the electronic document in response to the verification hash tree failing to satisfy the hash tree.

7. The method of claim 1, further comprising determining a root associated with the hash tree in response to hashing an entire set of tuples associated with the electronic document.

8. The method of claim 7, further comprising generating a redacted set of tuples that removes the verification numbers from the entire set of tuples that correspond to redacted portions of the electronic document.

9. The method of claim 7, further comprising publishing via the Internet the redacted set of tuples associated with the electronic document.

10. A system, comprising:
a hardware processor; and
a memory device, the memory device storing instructions, the instructions when executed causing the hardware processor to perform operations, the operations comprising:
receiving verification numbers sent via the Internet from a client device, the client device sending the verification numbers to claim a possession of an unredacted version of an electronic document;
generating a verification hash tree based on the verification numbers sent by the client device and an electronic representation of a hashing algorithm;
retrieving a hash tree known to be associated with the unredacted version of the electronic document;
comparing the verification hash tree to the hash tree to verify the claim of the possession; and
determining the client device possesses a redacted version of the electronic document in response to the verification hash tree failing to satisfy the hash tree associated with the unredacted version of the electronic document.

11. The system of claim 10, wherein the operations further comprise determining the verification hash tree satisfies the hash tree.

12. The system of claim 11, wherein the operations further comprise verifying the possession of the unredacted version of the electronic document in response to a satisfaction of the verification hash tree compared to the hash tree.

13. The system of claim 10, wherein the operations further comprise denying the possession of the unredacted version of the electronic document in response to the failing of the verification hash tree to satisfy the hash tree.

14. The system of claim 10, wherein the operations further comprise determining a root associated with the hash tree in response to hashing an entire set of tuples.

15. The system of claim 14, wherein the operations further comprise generating a redacted set of tuples that removes the verification numbers that correspond to redacted portions of the unredacted version.

16. The system of claim 15, wherein the operations further comprise publishing via the Internet the redacted set of the tuples.

17. The system of claim 14, further comprising:
dividing the unredacted version of the electronic document into chunks of data; and
assigning one of the verification numbers to each one of the chunks of data.

18. A memory device storing instructions that when executed cause a hardware processor to perform operations, the operations comprising:
dividing an electronic document into chunks of data;
assigning verification numbers to the chunks of data;
determining a root associated with a hash tree in response to hashing the verification numbers assigned to the chunks of data using an electronic representation of a hashing algorithm;
publishing the root via a blockchain via the Internet;
generating a redacted version of the electronic document, the redacted version removing at least one of the chunks of data that corresponds to confidential information redacted from the electronic document;
generating a redacted set of tuples associated with the redacted version of the electronic document, the redacted set of tuples removing the verification numbers that correspond to the confidential information redacted from the electronic document;
publishing the redacted set of the tuples via the Internet;
receiving a claim of possession sent via the Internet from a client device, the claim of possession claiming a possession of an unredacted version of the electronic document, the claim of possession comprising the verification numbers allegedly associated with the unredacted version of the electronic document;
generating a verification hash tree based on the verification numbers sent from the client device and the electronic representation of the hashing algorithm;
comparing the verification hash tree to the hash tree to verify the claim of possession; and
determining the client device possesses the redacted version in response to the verification hash tree failing to satisfy the hash tree.

19. The memory device of claim 18, wherein the operations further comprise determining the verification hash tree satisfies the hash tree.

20. The memory device of claim 18, wherein the operations further comprise verifying the claim of possession in response to the verification hash tree satisfying the hash tree.
